(19) United States
(12) Patent Application Publication
(10) Pub. No.: US 2006/0158414 A1
(43) Pub. Date: Jul. 20, 2006

(54) STORAGE DEVICE EQUIPPED WITH BISTABLE DISPLAY

(76) Inventor: Hseu-Hon Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/905,727

(22) Filed: Jan. 18, 2005

(51) Int. Cl. G09G 3/36

(52) U.S. Cl. 345/98

(57) ABSTRACT

A storage device is disclosed that includes a housing; a storage medium for storing data; a bistable display; and a control unit electrically connected to the storage medium and the bistable display for receiving power from an external host device or an access point so as to control the bistable display to display information corresponding to the storage medium.

### BACKGROUND OF INVENTION

1. Field of the Invention

The present invention relates to data storage apparatus, and more particularly, to data storage apparatus equipped with bistable displays.

2. Description of the Prior Art

Advances in data storage technology, have resulted in smaller, lighter, more portable, and larger storage capacity data storage devices. Therefore, portable data storage solutions become more important and essential for many people.

There are many kinds of portable storage devices, such as USB flash drives, Microdrives, mini HDDs, PDAs, digital voice recorders, electro-optical disk drives (MO), MP3 players, and other portable electronics. Only some of these portable storage devices are equipped with a battery providing the capability to perform various functions stand-alone (i.e., while not connected to any other device). For example, many USB flash drives and mini HDDs are made for data storage utilization only by supporting the Plug-and-Play function.

Portable storage devices that are not equipped with a battery require power from another source such as that received from an external host device via an industry-standard interface such as a USB or a 1394 cable. By utilizing such means, the volume and weight of these portable storage devices can be further reduced and the duration of battery power is not a concern for the user.

However, except for keeping the stored data, such portable storage devices cannot perform any operations once disconnected from the host device due to the lack of a power source within the portable storage device itself. In some situations, this is inconvenient for the user when there is a need to know some information or status about the storage device such as the utilized storage capacity, the available storage capacity, the last update date, etc. In view of the foregoing, it can be appreciated that a substantial need exists for methods and apparatus that can provide necessary information or status of the storage device to the user.

### SUMMARY OF INVENTION

It is therefore an objective of the claimed invention to provide a storage device that is not equipped with batteries to solve the above-mentioned problem.

An exemplary embodiment of a storage device is disclosed comprising: a housing; a storage medium for storing data; a bistable display; and a control unit electrically connected to the storage medium and the bistable display for receiving power from an external host device so as to control the bistable display to display information corresponding to the storage medium.

An exemplary embodiment of a method for displaying information corresponding to a storage medium positioned inside a housing is disclosed comprising: providing a bistable display on or inside the housing; and receiving power from a host device or an access point outside the housing for controlling the bistable display to display the information corresponding to the storage medium.

Another exemplary embodiment of a storage device is disclosed comprising: a housing; a storage medium for storing data; a bistable display; an antenna for receiving wireless signals from an external access point; and a control unit electrically connected to the storage medium, the bistable display, and the antenna, the control unit for controlling the bistable display to display information corresponding to the storage medium when the antenna receives the wireless signals.

One advantage of the present invention is that no power source need be installed within the storage device therefore the volume and weight of the storage device will not be significantly increased.

Another advantage of the present invention is that the user can obtain useful information about the storage device when the storage device is disconnected from all other devices.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a storage device according to a first embodiment of the present invention.

FIG. 2 is a block diagram of a storage device according to a second embodiment of the present invention.

FIG. 3 and FIG. 4 are two different packaging cases for the storage device in accordance with the present invention.

### DETAILED DESCRIPTION

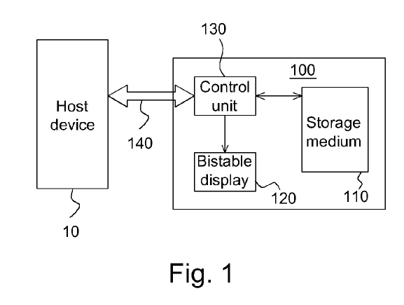

Please refer to FIG. 1, which illustrates a block diagram of a storage device 100 according to a first embodiment of the present invention. As shown in FIG. 1, the storage device 100 comprises a storage medium 110, a bistable display 120, and a control unit 130. The control unit 130 is electrically connected to the storage medium 110 and the bistable display 120. In this embodiment, the storage device 100 is a portable storage device, but this is merely an embodiment and not a restriction of the applications of the present invention. In practical implementations, the storage device 100 may be a USB flash drive (also known as a Pen drive), a hard disk drive (including Macrodrives and mini HDDs), or other storage devices that lack a power source. The operations of respective components of the storage device 100 are described below.

The storage medium 110 is utilized for storing data and is typically a non-volatile storage medium. For example, the storage medium 110 may be a flash memory (including various memory cards), a hard disk drive, an electro-optical disk drive (MO), or other solid-state storage medium. While the storage device 100 is connected to a host device 10 through an industry-standard interface 140 such as a USB or a 1394 interface, the power required for the storage device 100 is supplied from the host device 10 via the interface 140. Generally, the host device 10 is a PC, notebook, PDA, or various other electronics supporting on-to-go (OTG) function. In this embodiment, when the control unit 130 is powered, it is enabled to determine some information or status about the storage medium 110. For example, the control unit 130 may determine the utilized storage capacity, the remaining storage capacity, the last update date, the volume name, and other status information. Information or status of the storage medium 110 to be determined is programmed in the firmware of the storage device 100 and may be accessed by the user through a selecting menus or dialogue boxes displayed on a monitor which may be connected to or installed in the host device 10.

When the information of the storage medium 110 is determined, the control unit 130 controls the bistable display 120 to display the information. Preferably, the control unit 130 updates the information shown on the bistable display 120. After the storage device 100 is disconnected from the host device 10, the bistable display 120 is capable of displaying the last updated information without any power consumption. As a result, even when the storage device 100 is stand-alone (i.e., not connected or plugged into any host device), the last updated information of the storage medium 110 will be maintained and shown on the bistable display 120 for the user to understand the status of the storage device 100 at any time and any place.

The bistable display 120 can be implemented with various present and future techniques, such as an electrophoretic display, a bistable cholesteric display (BCD), a bistable TN display, a smectic C ferroelectric liquid crystal display, a Zenith bistable display (ZBD), a Gyricon Smart Paper, a BiNem® display, a QR-LPD® display and an E-ink display, etc.

In the aforementioned embodiment the control unit 130 is designed to directly drive the bistable display 120. In another embodiment, the storage device 100 further comprises a driver circuit (not shown) that is electrically connected to the bistable display 120 and the control unit 130. The driver circuit is utilized for driving the bistable display 120 under the control of the control unit 130.

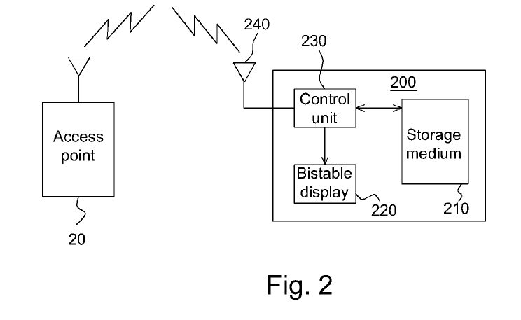

Please refer to FIG. 2, which depicts a block diagram of a storage device 200 according to a second embodiment of the present invention. The storage device 200 comprises a storage medium 210, a bistable display 220, a control unit 230, and an antenna 240. As shown, the control unit 230 is electrically connected to the storage medium 210, the bistable display 220, and the antenna 240. In this embodiment, the storage device 200 communicates with an external access point (AP) 20 through a predetermined wireless communication protocol, such as: IRDA, WIFI, RF, UWB (ultra wideband), etc.

The storage medium 210 and the bistable display 220 are substantially the same as the storage medium 110 and the bistable display 120 mentioned above and further details are omitted here. The antenna 240 is utilized for receiving wireless signals transmitted from the access point 20 and for generating power according to the wireless signals. The power generated by the antenna 240 is then supplied to the control unit 230 so as to enable the control unit 230. Since the operation of the antenna 240 to generate power according to the wireless signals is well known in the art further details are omitted for brevity.

When the control unit 230 is powered, the operation of the control unit 230 is substantially the same as the control unit 130. In some applications the control unit 230 might only comprise a wireless transmission module or might comprise a wireless transmission module and, for example, a wireless protocol decompressor, for communicating with the access point 20. Similarly, the control unit 230 could be designed to directly drive the bistable display 220 or to drive the bistable display 220 through a driver circuit (not shown).

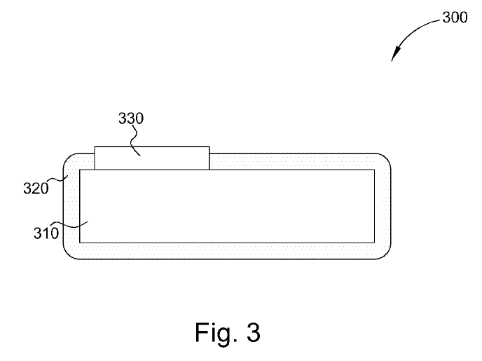

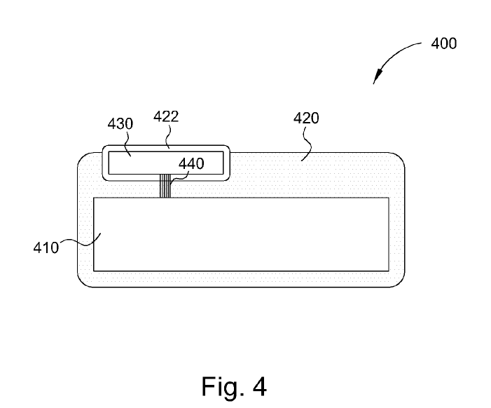

Additionally, it should be appreciated by those of ordinary skill in the art that the storage device 100 or 200 is typically covered within a housing so as to protect the circuit board and components of the storage device. Depending upon the design choice and practical applications, the bistable display may be positioned on or inside the housing. For example, FIG. 3 and FIG. 4 illustrate two different packaging cases for the storage device in accordance with the present invention. In FIG. 3, a storage device 300 comprises three portions: a main module 310, a housing 320, and a bistable display 330. The main module 310 represents most components of the storage device 300, such as the control unit and the storage medium other than the bistable display 330. In this case, the bistable display 330 is positioned on the housing 320 so that the user can directly watch the information shown on the bistable display 330.

In FIG. 4, a storage device 400 comprises four portions: a main module 410, a main housing 420, a sub-housing 422, and a bistable display 430. In this case, the bistable display 430 is mounted in the sub-housing 422 and connected to the main module 410 via a bus 440. The sub-housing 422 is utilized for protecting the bistable display 430 and is typically made of a transparent material such as acrylic or other resin. Technically, the main housing 420 and the sub-housing 422 are regarded as a whole. For example, the main module 410 may be a hard disk drive while the main housing 420 is a movable HDD box equipped with the bistable display 430 that is mounted in the sub-housing 422. In this situation, the sub housing 422 is regarded as a portion of the HDD box 420 so that the bistable display 430 can be regarded as being positioned inside the HDD box 420.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A storage device comprising:
a housing;
a storage medium for storing data;
a bistable display; and
a control unit electrically connected to the storage medium and the bistable display for receiving power from an external host device so as to control the bistable display to display information corresponding to the storage medium.

2. The storage device of claim 1, wherein the bistable display is positioned on the housing.

3. The storage device of claim 1, wherein the bistable display is positioned inside the housing.

4. The storage device of claim 1, wherein the storage device is portable.

5. The storage device of claim 1, wherein the control unit is further utilized for determining the information to be shown on the bistable display when receiving power from the external host device.

6. The storage device of claim 1, wherein the bistable display is an electrophoretic display, a bistable cholesteric display (BCD), a bistable TN display, a smectic C ferroelectric liquid crystal display, a Zenith bistable display (ZBD), a Gyricon Smart Paper, a QR-LPD® display, a BiNem® display or an E-ink display.

7. The storage device of claim 1, wherein the storage medium is a non-volatile storage medium.

8. The storage device of claim 7, wherein the non-volatile storage medium is a flash memory, a hard disk drive, or an electro-optical disk drive (MO).

9. The storage device of claim 1, further comprising:
a driver circuit electrically connected between the bistable display and the control unit for driving the bistable display under the control of the control unit.

10. A method for displaying information corresponding to a storage medium positioned inside a housing, the method comprising:
providing a bistable display on or inside the housing; and
receiving power from an host device or an access point outside the housing for controlling the bistable display to display the information corresponding to the storage medium.

11. The method of claim 10, further comprising determining the information to be shown on the bistable display when receiving the power from the host device or the access point.

12. A storage device comprising:
a housing;
a storage medium for storing data;
a bistable display;
an antenna for receiving wireless signals from an external access point; and
a control unit electrically connected to the storage medium, the bistable display, and the antenna, the control unit for controlling the bistable display to display information corresponding to the storage medium when the antenna receives the wireless signals.

13. The storage device of claim 12, wherein the bistable display is positioned on the housing.

14. The storage device of claim 12, wherein the bistable display is positioned inside the housing.

15. The storage device of claim 12, wherein the storage device is portable.

16. The storage device of claim 12, wherein the antenna supplies power to the control unit when the antenna receives the wireless signals transmitted from the access point.

17. The storage device of claim 12, wherein the control unit is further utilized for determining the information to be shown on the bistable display when it is powered.

18. The storage device of claim 12, wherein the bistable display is an electrophoretic display, a bistable cholesteric display (BCD), a bistable TN display, a smectic C ferroelectric liquid crystal display, a Zenith bistable display (ZBD), a Gyricon Smart Paper, a QR-LPD® display, a BiNem® display or an E-ink display.

19. The storage device of claim 12, wherein the storage medium is a non-volatile storage medium.

20. The storage device of claim 12, further comprising:
a driver circuit electrically connected between the bistable display and the control unit for driving the bistable display under the control of the control unit.
